(19) United States
(12) Patent Application Publication
(10) Pub. No.: US 2014/0110322 A1
(43) Pub. Date: Apr. 24, 2014

(54) CAPILLARY ASSEMBLY USEFUL AS CONNECTING CAPILLARY

(71) Applicant: Ole Vorm, Odense M (DK)

(72) Inventor: Ole Vorm, Odense M (DK)

(73) Assignee: PROXEON BIOSYSTEMS A/S, Odense C (DK)

(21) Appl. No.: 14/111,351

(22) PCT Filed: Apr. 11, 2012
(86) PCT No.: PCT/DK2012/050120

§ 371 Date: Nov. 20, 2013

Related U.S. Application Data
(60) Provisional application No. 61/474,344, filed on Apr. 12, 2011.

(30) Foreign Application Priority Data
Apr. 12, 2011 (DK) PA 2011 00288

(51) Int. Cl. B01D 15/22; G01N 30/60; B29D 23/00

(52) U.S. Cl. CPC B01D 15/22; B29D 23/00; G01N 30/60
USPC 210/198.2; 264/279

(57) ABSTRACT

There is provided a capillary assembly suitable for connecting various components of an analytical measuring device, for example a liquid chromatograph or a capillary electrophoresis device, to each other. Specifically, this involves reinforcing the fragile tubing by the addition of PEEK or steel sleeves and/or embedding the tubing in an injection-molded resin such that the tubing is not exposed directly to operator handling and manipulation. Further functional improvement is obtained by including additional components inside the resin. Thereby a versatile and robust capillary assembly is achieved.

### FIELD OF THE INVENTION

The present invention relates to a capillary assembly suitable for connecting various components of an analytical measuring device, for example a liquid chromatograph or a capillary electrophoresis device, to each other.

### BACKGROUND OF THE INVENTION

In a liquid chromatographic (LC) system, connecting capillaries, as well as columns made from capillaries, are often used.

In a liquid chromatographic system, the LC column is located between an injector and an LC detector to separate one or more constituents of interest from the various interferences in a sample to permit detection of these constituents of interest by an LC detector.

Capillary LC is a micro-version of traditional liquid chromatography and its popularity has grown rapidly during the past decades. Capillary LC columns have extremely low solvent consumption and require low volumes of samples for analysis. NanoLC is the name given to further miniaturization of chromatography, where flow-rates are typically below 1,000 nL/min and column diameters are typically around 75 μm (inner diam.). Analogous to traditional liquid chromatography, nano-LC and capillary-LC also consists of a micro-pump, a capillary column, a detector, and a data processing device. The capillary column is important to the system because it is where the separation process occurs.

A capillary LC column is manufactured by packing a capillary column with silica media, such as bonded silica particles, also referred to as packing material. Different types of materials, such as fused silica glass, stainless steel, and high-tensile polymers, have been used for capillary columns. Due to their unique features, fused silica glass capillaries are the most common for preparation of capillary LC columns. Fused silica capillary columns have inner diameters of less than 1 mm and, typically, less than 0.25 mm. They are strong and can withstand high packing pressure. It is easy to control their column dimensions during manufacturing, and the columns do not deform during packing. Further, the wall of a fused silica capillary is smooth, which is very desirable for packing.

Although fused silica capillaries have some unsurpassed advantages, they do have certain limitations. The most significant limitation stems from the brittle and fragile nature of the glass material from which they are made. The fragile nature of a thin, fused silica capillary makes packing, shipping, and handling difficult. A layer of polyimide is generally coated on the outside of the fused silica capillary for protection. However, if the polyimide layer has incurred even a small scratch during production or handling, it will lose its effect and the capillary can break with just a gentle touch.

To avoid damage to the packed capillary LC column, a shielding layer of stainless steel is sometimes provided for protection. Although the currently available steel shield do prevent the capillaries from breaking, they are rigid and thus require long connecting capillaries to install the capillary column between the injector and the detector of an LC system. This generates unnecessary extra column dead volume which degrades separation efficiency. Moreover, a separate assembly process is required in addition to the packing process, which will add extra cost to capillary LC column production.

When connecting a fused silica glass column firmly to another component, a sleeve is often needed to tighten and secure an end-fitting on the end of the capillary column. During the packing process, one end of the capillary is typically enclosed with an end-fitting assembly and the other end is connected to a slurry reservoir. A flexible sleeve is employed in the end-fitting assembly during packing because sufficient tightening is required to enclose the end for high pressure packing. The sleeve facilitates tightening and compensates for the size of the capillary, which is too narrow for the end-fitting. The packing pressure can force the end-fitting assembly open if there is insufficient tightening, while too much tightening can damage the capillary.

One particular use of HPLC is in the field of proteomics, i.e. the study of the entire protein complement of a cell or tissue sample where proteolytic fragments of proteins (e.g. peptides) are separated by HPLC prior to detection by mass spectrometry. Since the samples being analyzed in proteomics experiments are typically very complex and available in only very low quantities, it is frequently a challenge to obtain sufficient sensitivity and analysis speed. Sensitivity is optimized by reducing the flow rate of the mobile phase in combination with use of nano-bore columns (i.e. columns of narrow inner diameter).

Whereas the use of nano-bore columns is required in order to optimize the analytical sensitivity, it does however cause a range of complications inasmuch as it is difficult to connect tubing of narrow inner diameter in a fail-safe manner; tubing with the required bore-size can only be manufactured in a certain small selection of fragile materials; and the narrow diameters used require a very high chromatographic pressure in order to force liquid through the tubing at the required flow rate.

WO2009/147001 A1 discloses an integrated separation column having various fittings. For example FIG. 1 of that document shows an embodiment, where the integrated column (including fittings and electrospray needle) is embedded in a plastic material. Meanwhile there is no disclosure of sleeves that can readily be connected with other means, such as pumps, valves, analytical devices etc. The fittings used in WO2009/147001 comprise sheaths (or tubes) on which the ferrules can be placed and tightened; such sheaths or metal tubes are commonly used in analytic chemistry. However, in WO2009/147001 A1 the entire assembly comprising column, sheaths and ferrules, is covered with plastic material, and hence the sheaths cannot be connected to other means without removing the plastic material covering the ferrules. Since the very aim of the invention described in WO2009/147001 A1 is to provide an integrated separation column including fittings, where the consumer has no access to the fittings (being covered by a plastic material), WO2009/147001A1 does not provide a generic capillary.

There is a need, therefore, for a means to facilitate the use of fragile column materials.

It is therefore an object of the present invention to provide a device that can protect the capillary during packing and handling, and alleviate the other shortcomings of the fragile fused silica capillary.

It is another object of the present invention to provide a capillary assembly for analytical measurement technology which has a small and substantially constant inner diameter, a smooth inner wall, and which can be equipped with end fitting in an easy way, and which does not have the previously mentioned disadvantages.

### SUMMARY OF THE INVENTION

The present invention solves the above problems by providing a means to facilitate the use of fragile column materials. This involves reinforcing the fragile tubing by the addition of steel or PEEK sleeves and/or embedding the fragile tubing in an injection-molded resin such that the fragile tubing is not exposed directly to operator handling and manipulation. Further functional improvement is obtained by including additional components inside the resin. Thereby a versatile and robust capillary assembly is achieved.

As mentioned above, the capillary assembly according to the present invention makes use of sleeves, preferably steel or PEEK-sleeves, provided only in the end regions of the capillary. In the regions of the capillary where there are no sleeves the capillary is coated by a flexible plasticlayer, which is in direct contact with the capillary. In that way an additional protection against scratches is achieved.

In a preferred embodiment of the invention the glass capillary is a fused silica glass capillary; however, other materials can also be used, for example boro-silicate glass and thin-walled polymer and metal tubing.

The present invention is based on a method by which a capillary column, such as a silica glass capillary column, or connecting capillary tubing along with the accompanying end sleeves for connection via a fitting with adjacent liquid conduits is embedded in a polymer matrix.

In accordance herewith, the present invention is directed to a method for producing a capillary assembly, preferably a fused silica assembly, said method comprising:
introducing a capillary with sleeves covering the capillary ends into a forming tool, said sleeves being adapted to closely fit the outer diameter of the capillary, and
molding a plastic material, preferably an elastic plastic material, within the forming tool thereby coating the capillary and sleeves with the plastic material;
wherein the plastic material coats the capillary and a part of the sleeves, leaving a non-coated area of the sleeves for connecting with other means.

The present invention also provides a capillary assembly comprising:
a capillary, preferably a fused silica capillary, having a first end and a second end,;
sleeves covering the ends of the capillary, said sleeves being adapted to closely fit the outer diameter of the capillary; and
a molded plastic coating, preferably from an elastic plastic material, coating the capillary and a part of the sleeves, leaving a non-coated area of the sleeves for connecting with other means.

It is important to stress that molded plastic coating exclusively coats the capillary and a part of the sleeves, and not e.g. ferrules or other fittings as in WO2009/147001 A1. Accordingly, the capillary assembly of the present invention can be readily disconnected from the means it is connected to, which is in contrast to the integrated device in WO2009/147001 A1, where the connection is limited to the specific fitting protruding from the coating material.

Plastifying the part may be achieved in various ways, preferably by heating the plastic material beyond the softening temperature for bringing it in its softening range and making it soft. In a preferred embodiment the entire column and fittings are surrounded by the plastic material. The molding part may be a pre-formed part adapted to the shape of the silica capillary and of the forming tool.

The forming of the molding part may be achieved by closing the forming tool and exerting pressure on the pre-formed part. Alternatively, this is achieved by closing the forming tool and heating the forming tool together with the plastic material.

In preferred embodiments of the present invention, the forming of the molded part may be achieved by injecting molten plastic material into a mold wherein the capillary with sleeves are located and allowing the molten plastic to embed these parts and cool off and harden to become solid. Alternatively, the molded part may be shaped by exerting pressure on the plastic material caused by the thermal expansion of the plastic material by heating the closed forming tool comprising the plastic material, alternatively by exerting pressure on the plastic material by closing the forming tool, or actively cooling down the plastic material and/or the forming tool. Still another alternative embodiment may be achieved by mixing chemicals that subsequently polymerize inside a mold thereby embedding the capillary with sleeves and other related components.

Preferably, the plastic materials of the present invention are thermoplastic hotmelts based on polyamide or polyurethane, such as those marketed under the tradename MacroMelt (Henkel Kommanditgesellschaft). These include at least one room-temperature-flowable polymerizable compound in combination with a polymeric matrix present in an amount sufficient to render the composition non-flowable at temperatures of at least about 49° C. The polymerizable compound or composition may be selected from a wide group of materials including anaerobics, epoxies, acrylics, polyurethanes, olefinic compounds and combinations thereof.

### BRIEF DESCRIPTION OF THE DRAWINGS

FIG. 1 shows a fused silica capillary assembly of the present invention with PEEK sleeves at each end resin covering the central part of the capillary including approximately one third of the central end of each sleeve.

FIG. 2 shows an injection mold used to produce capillary assembly of FIG. 1.

FIG. 3 illustrates a pre-molding process of a coiled piece of fused silica.

FIG. 4 shows the product obtained from the process illustrated in FIG. 3.

FIG. 5 illustrates a continuous molding process, wherein a mold that is shorter than the desired length of the embedded tubing can be made open-ended.

FIG. 6 shows a column made from fused silica tubing and mated with an electrospray emitter at one end and coiled up alongside a heating filament and disc-shaped element that facilitates shaping the coil.

FIG. 7 shows the product obtained from the process illustrated in FIG. 6.

FIG. 8 shows molding where the resin goes onto and inside a ferrule.

### DETAILED DESCRIPTION OF THE INVENTION

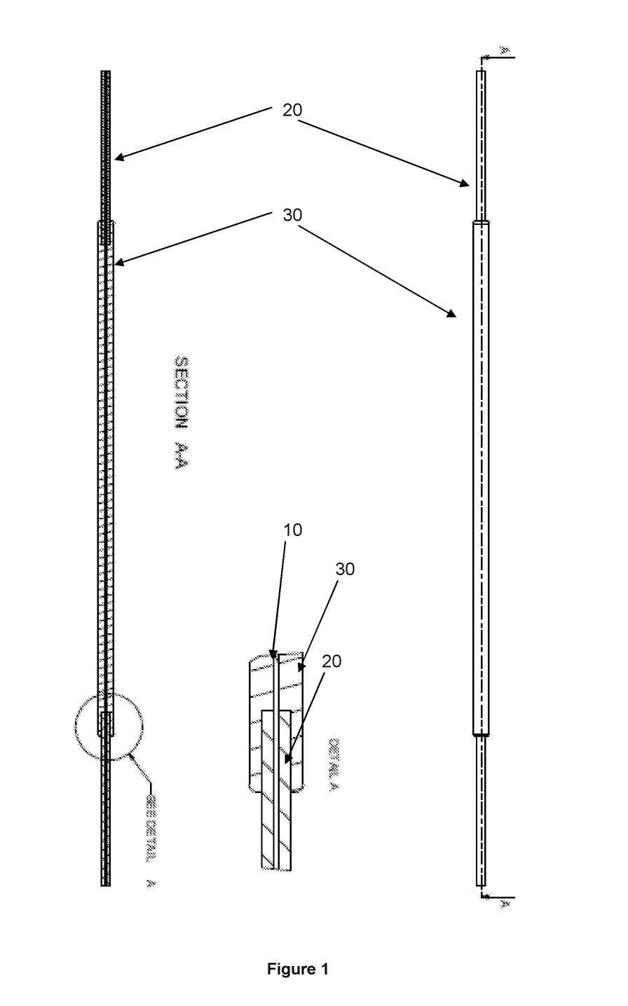

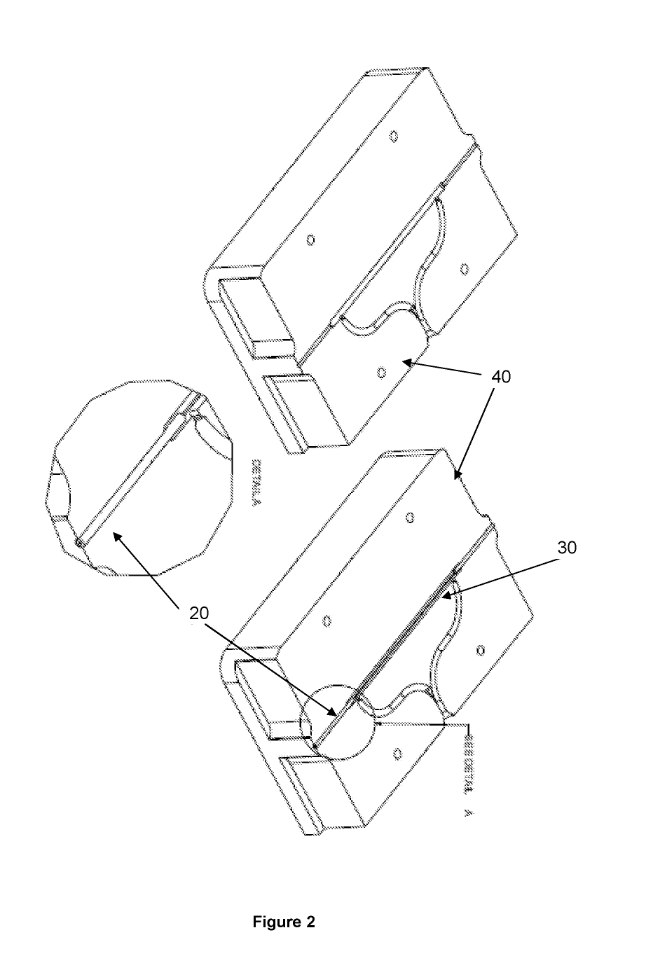

The arrangement as shown in FIGS. 1 and 2 comprises a silica capillary with sleeves. The molding material comprises a plastic material, for example, a thermoplastic material, such as polyamide and polyurethane based MacroMelt™. The plastic material is chosen for being formed with a forming tool comprising a mold. In some embodiments, the plastic material can be melted completely and afterwards cooled down to ambient temperature. Therefore, the plastic material can realize a chemical bond with the outer surfaces of the capillary and sleeves.

Specifically FIG. 1 shows a fused silica capillary (10) ˜360 μm OD with PEEK or steel sleeves (20) at each end and resin (30) that covers the central part of the capillary (10) including approximately one third of the central end of each sleeve (20). Detail A of FIG. 1 shows the overlap of resin onto the sleeve. Regardless of the material used for the sleeve, typical sleeve dimensions would be an inner diameter of ˜375 μm, length of approximately 3 cm and an outer diameter of 1/16″, which is a widely used standard size for HPLC tubing and fitting systems.

FIG. 2 shows an injection mold used to produce capillary assembly of FIG. 1, where the PEEK (or steel) sleeves (20) are held tightly by the mold (40) at each end, thereby creating a well defined end-point for the resin (30) covered segment.

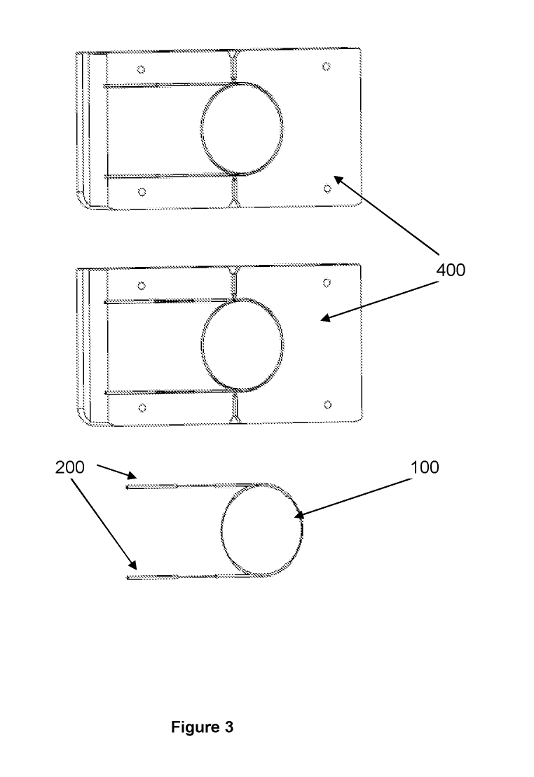

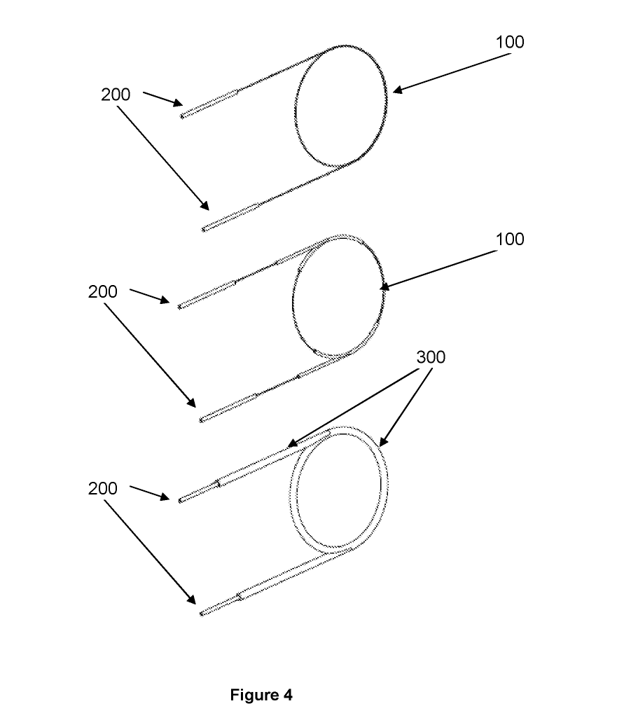

FIG. 3 shows pre-molding of a coiled piece of fused silica (100) with sleeves (200). The mold (400) and its resulting product is exemplifying how a small segment of a piece of fused silica tubing (100) can be embedded in a first molding process in order to obtain a particular desired shape of the end product, which will only obtain its final form through two or more consecutive molding steps. An example of such a product obtained by a two-step molding process is shown in FIG. 4, where the coating plastic material (300) covers a part of the sleeves (200).

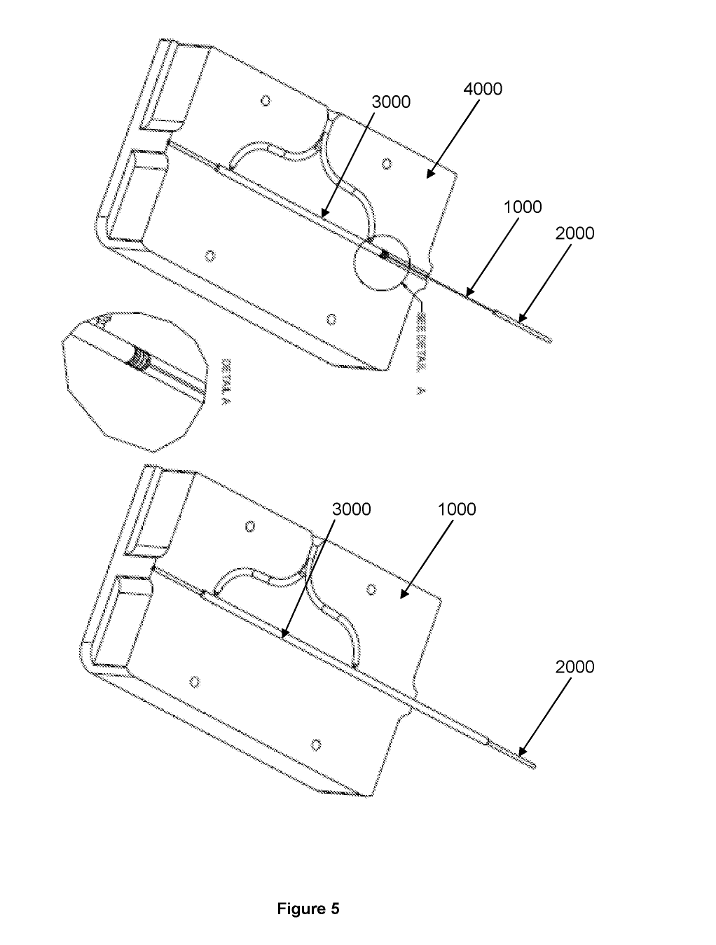

FIG. 5 shows a “continuous” molding process, where a mold that is shorter than the desired length of the embedded tubing (1000) can be made open-ended by temporarily inserting a cylindrical piece that may be removed once the resin has hardened, upon which the mold is transposed and another round of resin is injected until a sleeve (2000) is reached. The mold (4000) can be shaped such that the resin (3000) from two consecutive injections overlaps (concentrically) over a small stretch for added strength.

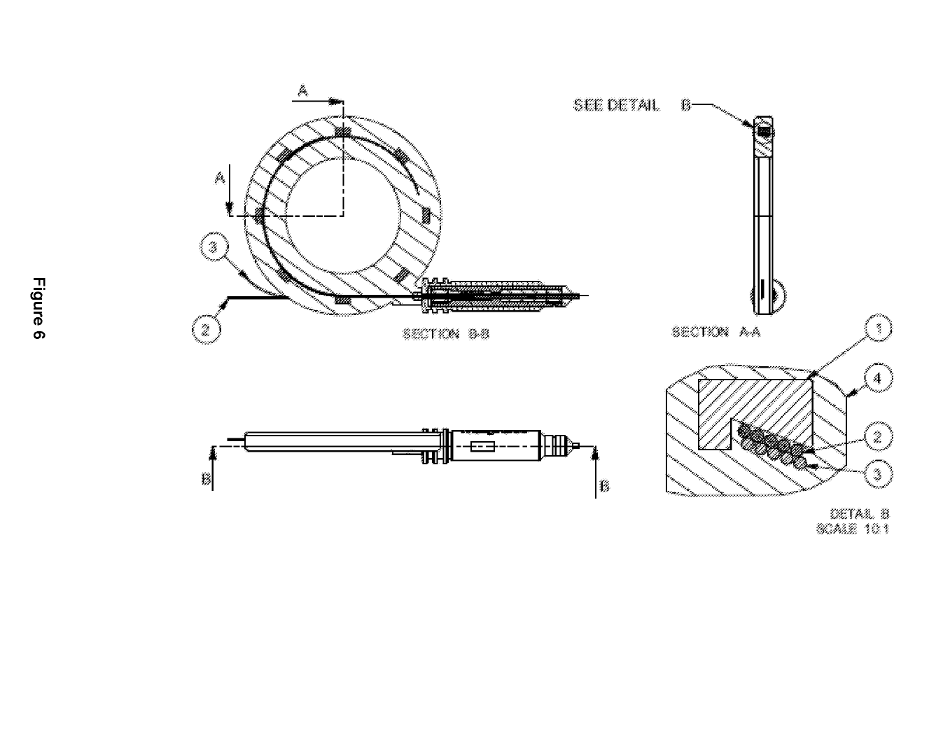

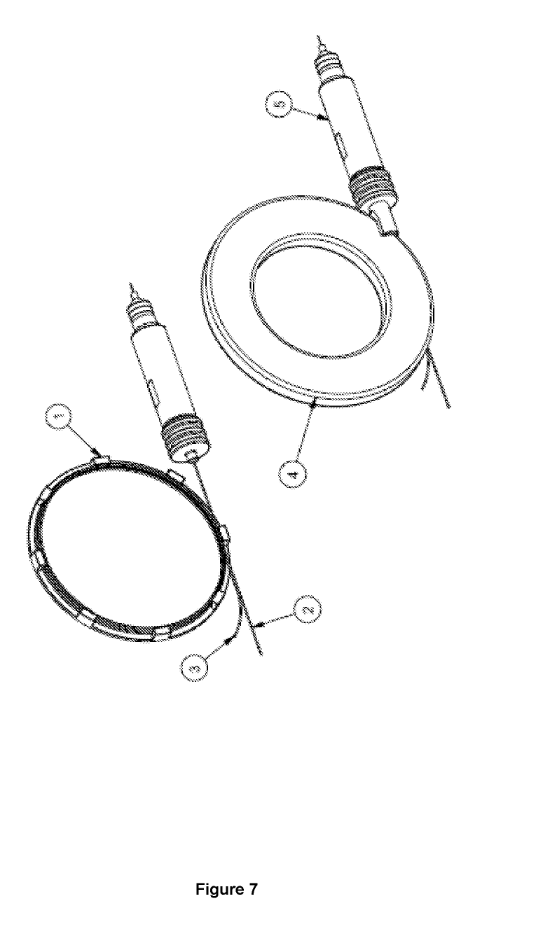

In FIG. 6 there is shown a column made from fused silica tubing and mated with an electrospray emitter at one end and coiled up alongside a heating filament and a disc-shaped element that facilitates shaping the coil. Section B-B shows a cross sectional view of said assembly where part (2) is the actual column and part (3) is the end of the heating filament. Detail B presents a cross sectional view of the disc-shaped element (1) and five windings of the column (2) in close proximity of 5 windings of the heating element (3). The boundary of the resin is shown (4). FIG. 7 shows the exterior of the embedded column and heating filament; the electrospray emitter is the component on the far right-hand side of the assembly. In this case the column is coiled with a diameter of around 5 cm and embedded in a ring-like resin shape. Other diameters and non-circular trajectories and other shapes can be chosen as well. The number of windings of column and heating wire may range from 1 to several hundred and the two materials may have disparate numbers of windings.

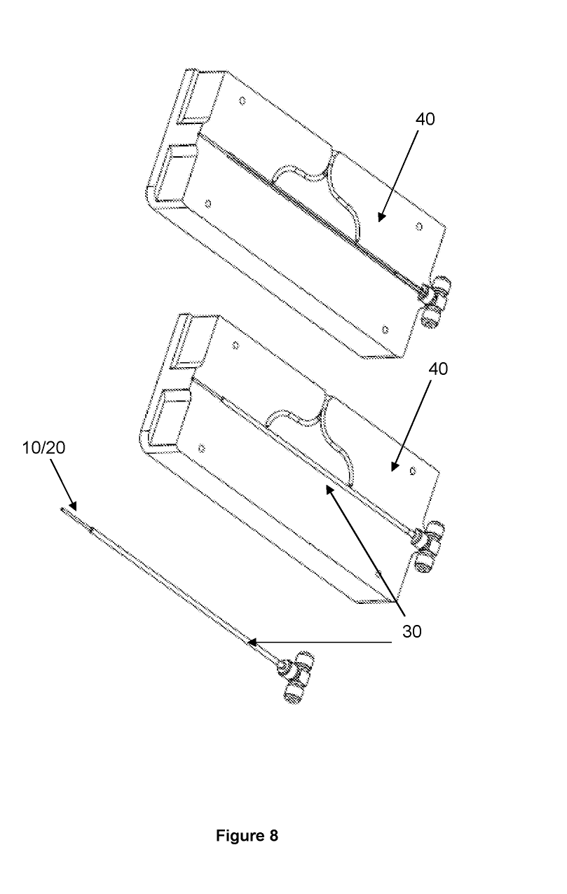

In FIG. 8 there is shown how molding may be achieved, wherein the resin (30) goes onto and inside a ferrule (50) thus locking this component to a well-defined position relative to the end of the sleeve/tubing (10/20) assembly during the injection molding process. The reference numerals equals those of FIG. 2.

According to the present invention, devices and techniques for HPLC applications are provided. Merely by way of example, the invention has been applied to a high pressure liquid chromatography process. But it would be recognized that the invention has a much broader range of applicability.

Embodiments may comprise one or more of the following: a part surrounding an HPLC column with end fittings that are plastified and molded within a forming tool for forming or for shaping the form of the integrated column and for fixing sleeves (and eventually end-fittings). The molding part comprises a plastic material. Advantageously, this technique enables sealing and positioning of sleeves and column. Advantageously, the forming tool can form the column to a desired shape with a good dimensional stability and a high reproducibility. Additionally, close tolerances can be held or maintained, for example, by exactly adjusting the process parameters like the temperature and the detention time within the forming tool.

The molding part can be realized as a pre-formed part, wherein the shape of the pre-formed part is adapted to the shape of the column/capillart and sleeves/fittings and of the forming tool. The pre-formed molding part can be plastified by heating the plastic material above or beyond the softening temperature and bringing it in its softening range for making it soft and pliable. Advantageously, the plastified plastic material can be evenly formed to the outer surfaces of the column and fittings. This enables a homogenous force distribution across the surfaces. Besides this, the mechanical stress after forming can be reduced.

In embodiments, the pre-formed molding part can comprise two or more component parts, wherein said component parts are joined to each other.

Most advantageously, the molding part can be realized by injecting molten plastic material into a mold and allowing this to cool to such temperature where the plastic forms a stable solid which may be flexible or entirely rigid depending on the chosen chemical composition of the plastic material.

### Example Comparing Prior Art with the Present Invention

### Prior Art

Compared to standard HPLC designs, then UHPLCs (ultra-high pressure range HPLCs) are designed to generate the higher backing pressure by using e.g. stronger motors on pumps and stronger valves and composites inside valves and other active components. While these components can be made with due care and consideration from present materials, the currently most limiting element has been the tubing that carries the solvent at pressures above 5,000. For low-flow chromatography systems, i.e. flow rates below 5 mL/min, the outer diameter of the standard LC tubing is usually one of three standard sizes: 360 μm, 1/32″, and 1/16″. The inner diameters tend to range from 5 μm to 300 μm, but any size combination of 360 μm OD and more than 200 μm ID will have very thin wall thickness and will be too fragile for normal use and handling.

The material used for LC tubing is typically one of: steel (316), fused silica glass, or

PEEK. Newer types of tubing combine two of these materials in order to obtain select advantages associated with each of the materials. Unfortunately, whether materials are used separately or mixed, each existing type of tubing on the market has severe disadvantages that hinder their robust use in nano-flow LC at ultra high pressures. For instance:
PEEK tubing with an outer diameter of 1/16″ and very narrow ID (close to 10 μm) may be able to withstand pressures up to 10,000 PSI but usually not with organic solvents. For instance acetonitrile is often used in chromatography and causes acute damage to PEEK tubing at pressures higher than around 3,000 psi.
PEEKsil tubing consists of an inner core of fused silica glass (essentially a lining) with an outer layer of PEEK. PEEKsil tubing has a pressure rating of up to 12,500 PSI which is around 50% higher than for simple PEEK tubing, and PEEKsil is better able to withstand a wide range of organic solvents that tend to degrade PEEK. However, PEEKsil cannot be manufactured with inner diameters below 25 μm and it seems that the inner diameter of PEEKsil in general exhibits rather significant variation over a length of tubing. That is, a piece of tubing that nominally should have ID 25 μm may vary from 50 μm to 10 μm at different locations of the tubing. This uneven size leads to vastly higher flow restriction than a tube of uniform inner diameter would have and also the risk of blockage caused by particulate matter in the mobile phase of the LC will increase several fold. A further complication from the use of PEEKsil, is that the inner glass lining may break and fall off in little flakes at and next to the locations where ferrules are tightened in unions and fittings. Such flakes may subsequently block the flow stream through the tube or damage valves and other active components by scratching their surfaces. There are many ferrules on the market designed to overcome this problem of damaging the tubing ends, but none have entirely solved the problem.
Stainless steel is extremely robust in terms of pressures it will withstand, and it is usually straightforward to obtain leak-proof connections to unions and other fittings, using a wide variety of ferrules and nuts. Also steel tubing is able to withstand organic solvents of virtually every kind. However, steel tubing cannot be made with an inner diameter below 125 μm and usually the lower limit is in fact 250 μm when the OD is one of the two standards of 1/32″ or 1/16″. If one needs more narrow ID tubing then the OD must be reduced as well, upon which the tubing becomes fragile. Another complication of using steel tubing is that acidified aqueous buffers tend to cause corrosion and salt formation in steel tubing. And an additional complication is that some analytes, e.g. phospho-peptides tend to react with iron-ions of the steel surface and adsorb, disintegrate, or otherwise disappear from the sample.
Stainless steel tubing can be made with glass lining (e.g. catalog number 24951 from www.SigmaAldrich.com) which alleviates the chemical reactivity issues of steel but this tubing cannot be obtained with an inner diameter below 250 μm.
Fused silica glass tubing for chromatography purposes is made of glass where the outside is coated by a layer of poly-imide that has a thickness usually between 8 μm and 20 μm. Fused silica tubing without the polymer coating is extremely fragile and breaks even with careful handling and when exposed to only moderate pressure; hence it has no useful application as high pressure flow lines. The coated fused silica tubing on the other hand is very flexible and tolerates extensive bending (e.g. a 360 μm OD tube can be coiled up in loops of 4 cm in diameter without breaking). Studies have been reported where poly-imide coated fused silica tubing were used to transfer liquid at up to 200,000 PSI, i.e. ten times the upper attainable pressure limit of current UHPLC equipment. In other words, coated fused silica tends to be both flexible and strong. This is however only true of tubing where the coating is absolutely intact and it is a frequent observation that even slight scratches in the poly-imide coating will cause fracture of the fused silica tubing even at moderate pressures or strains.

Therefore, whereas multiple types of tubing for capillary and nano-flow chromatography exists, none of the existing materials or material combinations presents satisfactory solutions in terms of mechanical and physical robustness, chemical inertness, or selection of inner diameter.

### Present Invention

The present invention describes methodology and apparatus that provides greatly improved capillary tubing and column products. In a preferred implementation the new tubing is an assembled product that contains an inner core of fused silica glass tubing that is coated with poly-imide as most commonly used. The desired length of tubing is cut from a reel of tubing and each end is covered (i.e. sleeved) with a concentric polymer tube or steel tube that has a tight fit to the inner tube. That is, the OD of the fused silica tubing is few micrometers smaller than the ID of the sleeve. Then the portion of the fused silica tubing, that is not covered by the sleeves, is embedded in a polymer resin by injection molding (in a mold) that will subsequently harden to form a protective outer layer around the fused silica. The resin may also cover parts of the sleeves at one or both ends and it may also be advantageous to include additional components inside the resin embedded volume in order to provide additional functionality of the complete assembly.

This inner diameter of the fused silica tubing can be obtained in many dimensions while the outer diameter tends to conform to one of few standard sizes. In a preferred implementation the fused silica tubing is approximately 360 μm OD, a size for which sleeves are readily available. These sleeves often have an outer diameter of approximately 1/32″ or 1/16″ which again is a standard size for connectors and fittings used in the field of chromatography. Sleeves can be made of per-fluoro-polymers, steel, or PEEK in a preferred implementation. Normal lengths of sleeves range from around 2 cm to 5 cm.

Resin for injection molding may be of many chemical compositions. In a preferred implementation, a hotmelt resin based on poly-urethane (MacroMelt from Henkel) was used to give a robust but somewhat flexible material that binds well to the poly-imide layer of the fused silica tubing and also binds to the outer surface of the sleeves.

For resin embedded fused silica tubing when made according to the descriptions herein, we have found several advantages over the current state of the art, including:

When embedded in resin, fused silica is readily pressure proof up to about 20,000 psi when the inner diameter of the glass is less than 150 μm. The poly-imide layer cannot be scratched owing to the protective resin layer hence the assembly is robust even when handled and flexed while under pressure.

Sleeves and ferrules can be firmly coordinated relative to the liquid transfer conduit such that it facilitates leak proof assembly with fittings and other active components of an HPLC system.

1. A method for producing a capillary assembly, preferably a fused silica assembly, said method comprising:
introducing a capillary with sleeves that cover the capillary ends into a forming tool, said sleeves being adapted to closely fit the outer diameter of the capillary, and
molding a plastic material, preferably an elastic plastic material, within the forming tool thereby coating the capillary and sleeves with the plastic material; wherein the plastic material exclusively coats the capillary and a part of the sleeves, leaving a non-coated area of the sleeves.

2. The method of claim 1, where the sleeves are made from PEEK or steel or a combination of two concentric sleeves where a smaller inner sleeve of PEEK is inserted inside a larger sleeve of steel.

3. The method of claim 1, wherein molding the material is achieved by heating the plastic material beyond the softening temperature for bringing it in its softening range and making it soft.

4. The method of claim 1, wherein the plastic material is realized as a pre-formed part that gets adapted to the shape of the capillary and/or of the forming tool.

5. A capillary assembly comprising:
a capillary, preferably a fused silica capillary, having a first end and a second end;
sleeves covering the ends of the capillary, said sleeves being adapted to closely fit the outer diameter of the capillary; and
a molded plastic coating, preferably from an elastic plastic material, exclusively coating the capillary and a part of the sleeves, leaving a non-coated area of the sleeves.

6. The capillary assembly of claim 5, wherein the sleeves are of PEEK or PEEK derivative, steel, or a combination of steel and PEEK wherein a smaller PEEK sleeve is inserted inside a larger steel sleeve.

7. A capillary assembly of claim 5 wherein the assembly has been given an outer shape that fits to a counter-part in order to facilitate its subsequent installation in and use with an analytical measuring instrument.

8. A capillary assembly of claim 5 wherein the capillary is filled with stationary phase resin (i.e. chromatography material) such that the assembly becomes a chromatography column.

9. A capillary assembly of claim 8 wherein a heating element is embedded along with the chromatography column.
